(19) United States
(12) Patent Application Publication
(10) Pub. No.: US 2009/0289136 A1
(43) Pub. Date: Nov. 26, 2009

(54) LID MEMBER

(75) Inventors: Tetsuo Ishikawa, Tokyo (JP); Toshio Hiranuma, Saitama (JP); Hisashi Nakashima, Tokyo (JP)

Correspondence Address: SMITH-HILL AND BEDELL, P.C., 16100 NW CORNELL ROAD, SUITE 220, BEAVERTON, OR, 97006, US

(73) Assignee: MAX CO., LTD., Tokyo (JP)

(21) Appl. No.: 12/307,728

(22) PCT Filed: Jul. 4, 2007
(86) PCT No.: PCT/JP2007/063379

§ 371 Date: Jan. 6, 2009

(30) Foreign Application Priority Data
Jul. 7, 2006 (JP) 2006-188409

(51) Int. Cl. B02C 23/00

(52) U.S. Cl. 241/285.2

(57) ABSTRACT

To provide a lid body for a disposer apparatus which can keep inside of the disposer apparatus clean with ease. A washing-agent-reception portion is provided on a side of a rear surface of the lid body and at an inside of the body portion. The washing-agent-reception portion receives a washing agent package. When changing over drive of the disposer apparatus to a crushing operation for crushing garbage, water supply into the inside of the hopper starts concurrently with the crushing of the garbage by the crushing unit. Water to be supplied is supplied to the inside of the hopper through the lid body as a pathway thereof. At this time, the water passing through the lid body is supplied to the inside of the hopper as washing liquid with it dissolving washing agent. When driving the crushing unit, washing of the inside of the hopper is executed by the washing liquid concurrently with the crushing operation, which keeps the inside of the hopper clean.

### TECHNICAL FIELD

The present invention relates to a lid body. It particularly related to a lid body removable from a disposer apparatus main body, which is provided with a washing-agent-reception portion along a pathway in the lid body when water water-supplied during a crushing operation of the disposer apparatus main body is supplied to the disposer apparatus main body through the lid body as the pathway.

### BACKGROUND ART

In recent years, a disposer apparatus which crushes garbage such as raw garbage and the like generated in general households, restaurants and the like, and discharges it to drainage has been widely utilized. For a crushing system of a disposer apparatus, there has been widely employed a hammermill system one or a grinder type one in which a crushing unit stacked with a plurality of crushing blades is provided within a hopper of a disposer apparatus detachably.

A crushing unit rotates during a crushing operation of a disposer apparatus, so that a diameter of a garbage throw-in port of the disposer apparatus of hammermill system has been often designed so as to be small-sized (for example, 82 mm) for forbidding a user from touching the crushing unit directly. For that reason, it has been difficult to clean any residual substance remained in the inside of hopper after termination of crushing treatment. As a result thereof, the residual substance remained in the inside of hopper might decay so that slime or the like can be generated, which causes a bad smell.

Consequently, in order to clean the inside of hopper easily, a disposer apparatus of hammermill system in which a diameter of the throw-in port of the disposer apparatus is designed so as to be large-sized (for example, 130 mm) has been developed. On the other hand, also in a disposer apparatus of grinder type, while a diameter of the throw-in port thereof is large-sized, the throw-in port of the hopper is blocked by a lid body during a crushing operation of the disposer apparatus in order to prevent the user from touching the crushing unit directly.

However, also in these kinds of disposer apparatuses, it has not been able to resolve a problem such that the crushed residual substance easily remains at a bottom plate for guiding the crushed substance which has been crushed to a drainage port or a connection portion between the hopper and the drainage pipe in addition to an inner wall surface of the hopper, and for that reason, even if the diameter of the throw-in port of the disposer apparatus is large-sized, it has not been able to solve a problem such that the residual substance is removed perfectly.

Consequently, in order to remove the residual substance at the bottom plate or the like of the disposer apparatus as mentioned above, a disposer apparatus has been disclosed in which a crushing unit is constituted so as to be detachably from the hopper (see Japanese Patent Application Publication No. 2004-298809).

However, in the disposer apparatus disclosed in the above-mentioned publication, there is a problem such that the user himself must detach the crushing unit from the kitchen sink and clean the crushing unit and the inside of hopper when cleaning the inside of hopper or the like after the crushing treatment, to require a lot of effort and/or time. Also, when the user himself executes the washing, the connection portion between the hopper and the drainage pipe or the like is a place that is hard to clean, so that it has been difficult to remove the slime or the bad smell perfectly.

The present invention has been invented in view of the above-mentioned problems and the object thereof is to provide a lid body for a disposer apparatus in which it is possible to keep the inside of disposer apparatus clean.

### DISCLOSURE OF THE INVENTION

### Means for Solving the Problem

In order to solve the above-mentioned problems, the present invention is characterized by a lid main body which is constituted so as to be removable from a throw-in port of a disposer apparatus main body for throwing-in garbage and changes over the disposer apparatus main body to an operation thereof for crushing the thrown-in garbage together with water to be supplied, wherein the water to be supplied is supplied to the disposer apparatus main body through the lid main body as a pathway, and a washing-agent-reception portion is provided at least at a portion of the pathway of the lid main body.

When the disposer apparatus main body is changed over to a crushing operation thereof for crushing the garbage, water supply to the inside of the disposer apparatus main body starts together with the crush of the garbage by the crushing means. This supplied water is supplied to the inside of the disposer apparatus main body through the lid body as the pathway. In the present invention, the washing-agent-reception portion is provided on the pathway of the supplied water of the lid main body. For that reason, the supplied water is supplied to the disposer apparatus main body with it dissolving the washing agent when passing through the lid main body, and washing liquid in which the washing agent is dissolved in the water is supplied to the inside of the disposer apparatus main body. Consequently, washing treatment of the inside of the disposer apparatus is executed concurrently with the crushing treatment of the garbage.

A general neutral detergent, an enzyme decomposing oil content, one removing the slime, or one having a function of sterilization, disinfection, aroma, mold prevention, repression of microbe generation or the like may be used as the washing agent. Also, the washing agent may be any one of solid state, gel state and liquid state types, but the sold state type one is preferable.

Also, the lid body of the present invention is characterized in that an operation lid which is provided by covering the lid main body and is mounted so as to be able to rotate relatively with respect to the lid main body, a first opening which becomes a pathway of the water from the lid main body to the disposer apparatus main body is perforated in the lid main body, a second opening is perforated in the operation lid at a position with it being superposed on the first opening, when the disposer apparatus main body is in a crushing operation, a third opening which becomes a pathway of the water is constituted owing to superposition of the first opening on the second opening by rotating at least one of the lid main body and the operation lid to a superposed position of the first opening and the second opening and the washing-agent-reception portion is provided at a portion of the pathway of the water, and when the disposer apparatus main body is not in a crushing operation, a blocking portion for blocking the pathway of the water is constituted by rotating at least one of the lid main body and the operation lid to a position at which the first opening is not superposed on the second opening.

Although it is assumed that the lid body of the disposer apparatus is used so that it is removed from the disposer apparatus main body in a case excluding the crushing treatment, for example, when washing dishes, there may be also many cases in which the lid body is used so that it is mounted on the disposer apparatus main body. In such cases, if the washing agent remains at the reception in the lid body, the washing agent of the lid body is dissolved by the water used when washing the dishes, so that the washing agent is consumed in a short period of time, which causes an exchange frequency of the washing agent to be increased.

On the other hand, in the present invention, the third opening is constituted by superposing the first opening of the lid main body on the second opening of the operation lid only during the crushing treatment. Consequently, the lid body is constituted so that the washing agent can contact the water through the third opening only during the crushing treatment, by which the supply of the washing agent starts. Thus, the washing agent is prevented from being used during a period of time excluding the crushing treatment time and it is possible to repress unintentional consumption of the washing agent.

### EFFECT OF THE INVENTION

According to the present invention, the washing liquid is supplied during the crushing operation, so that washing of the inside of the disposer apparatus can be carried out concurrently with the crushing treatment. Consequently, it is possible to keep the inside of the disposer apparatus clean in a state in which the crushing unit is mounted on the disposer apparatus main body without being detached therefrom.

### BRIEF DESCRIPTION OF DRAWINGS

FIG. 1 is a cross-sectional view of a disposer apparatus relating to an embodiment of the present invention for showing a configuration thereof;

FIG. 2 is a cross-sectional view of a lid body for showing a configuration thereof;

FIG. 3A is a diagram showing a configuration of an upper surface of the lid body;

FIG. 3B is a diagram showing a configuration of a rear surface of the lid body;

FIG. 4A is a perspective view of a washing agent package for showing a configuration thereof;

FIG. 4B is a perspective view of the washing agent for showing a configuration thereof;

FIG. 4C is a cross-sectional view of the washing agent package taken along a line of A-A in FIG. 4A;

FIG. 5 is a diagram showing a state in which the washing agent package is mounted on a side of the rear surface of the lid body;

FIG. 6 is a diagram showing a state in which the washing agent package is mounted on a side of the upper surface of the lid body;

FIG. 7 is a cross-sectional view showing a state in which the washing agent package is mounted on a side of the upper surface of the lid body;

FIG. 8 is a perspective view of the washing agent package for showing a configuration thereof;

FIG. 9 is a cross-sectional view showing a state in which the washing agent package is mounted on the rear surface side of a handle portion of the lid body;

FIG. 10 is a diagram showing a side surface of the lid body;

FIG. 11A is a plan view of a first rotary crushing blade of a crushing unit for showing a configuration example thereof;

FIG. 11B is a front elevational view of the first rotary crushing blade of the crushing unit for showing a configuration example thereof;

FIG. 11C is a right side elevational view of the first rotary crushing blade of the crushing unit for showing a configuration example thereof;

FIG. 12A is a plan view of a first fixed crushing blade of the crushing unit for showing a configuration example thereof;

FIG. 12B is a front elevational view of the first fixed crushing blade of the crushing unit for showing a configuration example thereof;

FIG. 12C is a side elevational view of the first fixed crushing blade of the crushing unit for showing a configuration example thereof;

FIG. 13A is a plan view of a second rotary crushing blade of the crushing unit for showing a configuration example thereof;

FIG. 13B is a B-B cross-sectional view of the second rotary crushing blade shown in FIG. 13A;

FIG. 14A is a plan view of a second fixed crushing blade of the crushing unit for showing a configuration example thereof;

FIG. 14B is a C-C cross-sectional view of the second fixed crushing blade of the crushing unit;

FIG. 15A is a plan view of a third rotary crushing blade of the crushing unit for showing a configuration example thereof;

FIG. 15B is a side elevational view of the third rotary crushing blade of the crushing unit for showing a configuration example thereof;

FIG. 16 is a cross-sectional view of a disposer apparatus of an automatic water supply type relating to another embodiment of the present invention for showing a configuration thereof;

FIG. 17 is a diagram showing a configuration of a rear surface side of an upper lid;

FIG. 18 is a diagram showing a configuration of a bottom portion of a middle lid;

FIG. 19 is a plan view of a lid body in which the upper lid is mounted for showing a configuration thereof;

FIG. 20 is a cross-sectional view of the lid body taken along a D-D line in FIG. 19;

FIG. 21 is a cross-sectional view of a lid body relating to other embodiment of the present invention for showing a configuration thereof;

FIG. 22 is an exploded perspective view of the lid body for showing a configuration thereof;

FIG. 23A is a diagram explaining an operation of the lid body during other mode than a crushing mode; and

FIG. 23B is a diagram explaining an operation of the lid body during a crushing mode.

### BEST MODE FOR CARRYING OUT THE INVENTION

The following will describe the present invention based on embodiments thereof with reference to drawings. In each drawing used for the following explanation, a scale of each member is changed appropriately in order to allow a size of each member to be recognized. In the following explanation, a disposer apparatus of so-called manual water supply type in which the water is water-supplied manually during the crushing treatment of a disposer apparatus will be explained.

### First Embodiment

For the sake of the explanation, a disposer apparatus to which a lid body relating to this invention is applied will be first explained.

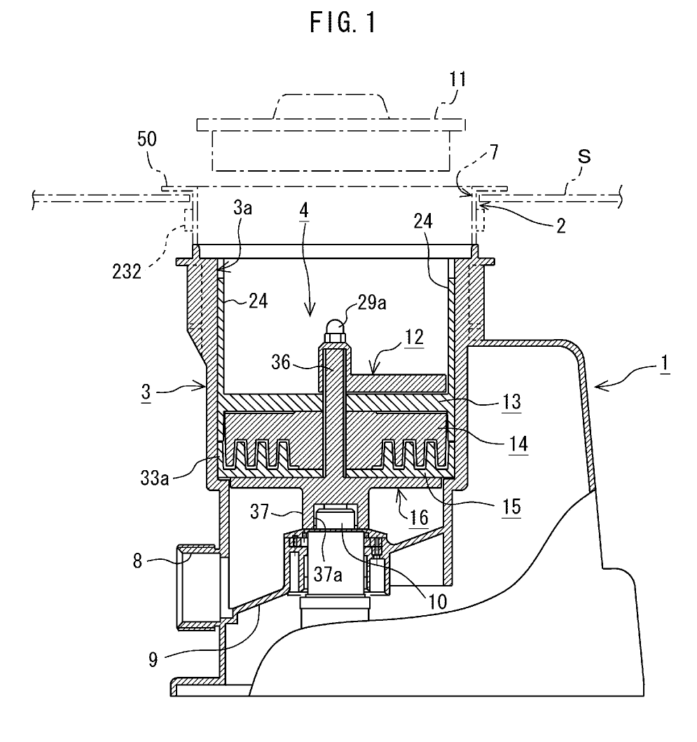

FIG. 1 is a front elevation cross-sectional view of a disposer apparatus 1 relating to this embodiment for showing an outline of a configuration thereof. The disposer apparatus 1 is illustrated as a grinder typed one. The disposer apparatus 1 is placed on a side of a lower surface of a kitchen sink S provided at a kitchen installation. The disposer apparatus 1 forms approximately a tube shape and includes a hopper 3 into which raw garbage or the like is thrown. An upper end of the hopper 3 is fitted and fixed on the inside, which corresponds to the hopper 3, of a throw-in opening portion 7 of the kitchen sink S through attaching means 2 (shown by chained lines).

A crushing unit 4 is mounted in the inside of the hopper 3 with it being detachably with respect to the hopper 3. The crushing unit 4 has a third rotary crushing blade 16 at the bottom stage and a fitting portion 37 provided at a lower surface of a hub thereof is fitted with a driving shaft 10 of a deceleration unit which is not shown. A lower portion of the hopper 3 which is an apparatus main body is formed to be a housing (case) for mounting-fixation with respect to the kitchen sink S and a drive motor and the deceleration unit as a driving means are installed in the inside thereof, which is not shown. The drive motor drives the rotary crushing blades of the crushing unit 4 through the deceleration unit and rotates them. Although the detail is not shown, the driving shaft 10 for transmitting a driving force to the crushing unit 4 and the fitting portion 37 with respect to the crushing unit 4 are formed as square shaft shapes, splined shaft shapes or the like.

The hopper 3 is a cylinder body having approximately a perpendicular cylindrical shape and on the inner periphery surface thereof, a pair of fitting portions (groove portions in this example) 3a which are extended from a side of the throw-in opening portion 7 toward the lower side thereof is formed at positions apart from each other at 180° in this example. The crushing unit 4 may be inserted into the throw-in opening portion 7 and pulled out thereof and is detachable with respect to the hopper 3. The detail thereof will be mentioned later.

A drainage pipe connection port 8 is provided at a lower end of a periphery surface of the hopper 3. A bottom plate 9 which is inclined toward this drainage pipe connection port 8 is provided in the inside of the hopper 3 and a center portion of the bottom plate 9 constitutes a bearing unit for receiving the driving shaft 10 of the deceleration unit.

A lid body (shown by chained lines) 11 is removably mounted on the inside of the hopper 3 corresponding to the throw-in opening portion 7. When using the disposer apparatus 1, the throw-in opening portion 7 is blocked by the lid body 11, which prevents a hand or the like from being inserted into the hopper 3 carelessly during the crushing treatment of the raw garbage and hinders the crushed raw garbage from being spattered onto a side of the kitchen sink S.

It is constituted such that the drive motor starts up in cooperation with the attaching-detaching and blocking operations of the lid body 11. For that reason, detection means (magnetic sensor 232, magnet 69 (see FIG. 10)) for detecting that the throw-in opening portion 7 is blocked flocked) by using permanent magnet or the like provided at the lid body 11 is provided. When it is detected by the magnetic sensor 232 provided at the attaching means 2 that the throw-in opening portion 7 is blocked, the driving or the like of the drive motor is controlled by a control means which is not shown.

Now, the hopper 3 in which such a crushing unit 4 is mounted is attached and fixed on the kitchen sink S through the attaching means 2. This attaching means 2 has a sink flange 50 as one example, this sink flange 50 is attached and fixed on the kitchen sink S, and the hopper 3 is fixed on the kitchen sink S through this sink flange 50.

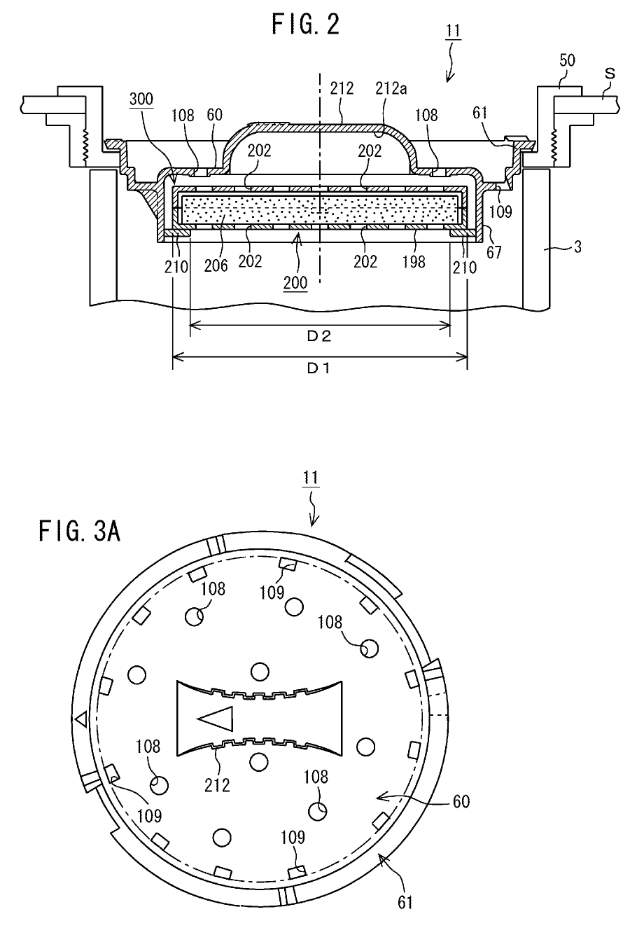

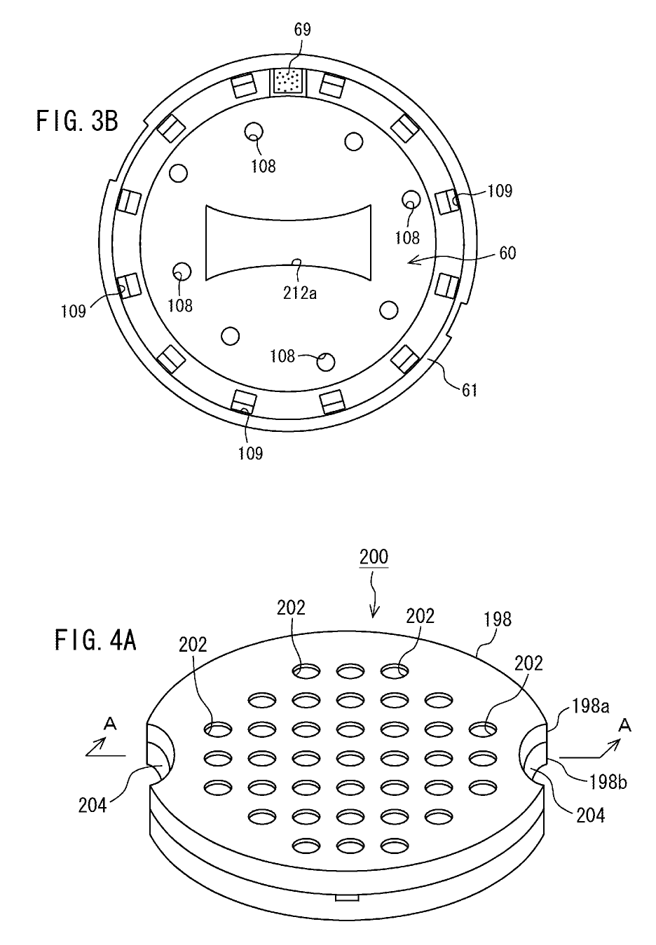

FIG. 2 is a cross-sectional view of the lid body 11 for showing a configuration thereof, FIG. 3A is a diagram showing a configuration of an upper surface of the lid body 11 and FIG. 3B is a diagram showing a configuration of a rear surface of the lid body 11.

As shown in FIG. 2, the lid body 11 contains a disk shaped top surface plate 60, a tube shaped body portion 67 which extends vertically to a downward direction from a periphery of this top surface plate 60, and an engagement flange 61 which is connected with the body portion 67 and the top surface plate 60 by molding them into one body and at the same time, extends vertically to an upward direction from the periphery of the top surface plate 60.

As shown in FIG. 2, FIG. 3A and FIG. 3B, in order to guide crushing water which is supplied from a side of the top surface plate 60 to the inside of the hopper 3 thoroughly, through-holes 108 for water injection, each of which forms into a circular shape, are perforated on the top surface plate 60 and through-holes 109 for water injection, each of which forms into a rectangular shape, are perforated in the vicinity of a circumference portion coupled with the engagement flange 61.

A handle portion 212 which is projected from the upper surface is provided approximately at a center portion of this upper surface of the lid body 11. The handle portion 212 has a cuboid that is approximately a rectangular shape seen from a plane thereof, both longitudinal sides of which are curved inward, thereby constituting a shape by which a user is easy to grasp it. Also, a hollow portion 212a (concave portion) is formed on a side of the rear surface of the handle portion 212 projected from the upper surface of the lid body 11. This hollow portion 212a is constituted to have approximately the same depth as the height of the handle portion 212 and the handle portion 212 has approximately the same thickness as that of the top surface plate 60.

Here, the disposer apparatus 1 of the present embodiment executes the rotary drive of the crushing unit 4 and the crushing treatment while water-supplying the water during the crushing treatment. In case of the manual water supply, the water to be supplied is supplied from a faucet provided on an upper side of the disposer apparatus 1 and is supplied into the inside of the hopper 3 through the lid body 11. In more detail, the water to be supplied flows into the through-holes 108, 109 for water injection provided on the top surface plate 60 from the upper surface of the lid body 11, and is supplied into the inside of the hopper 3 by way of the side of the rear surface of the top surface plate 60 and the inner periphery surface of the body portion 67. In the present embodiment, a reception portion 300 of a washing agent 206 is provided on the upper surface, the rear surface or the like of the lid body 11 which constitutes a pathway of the water to be supplied.

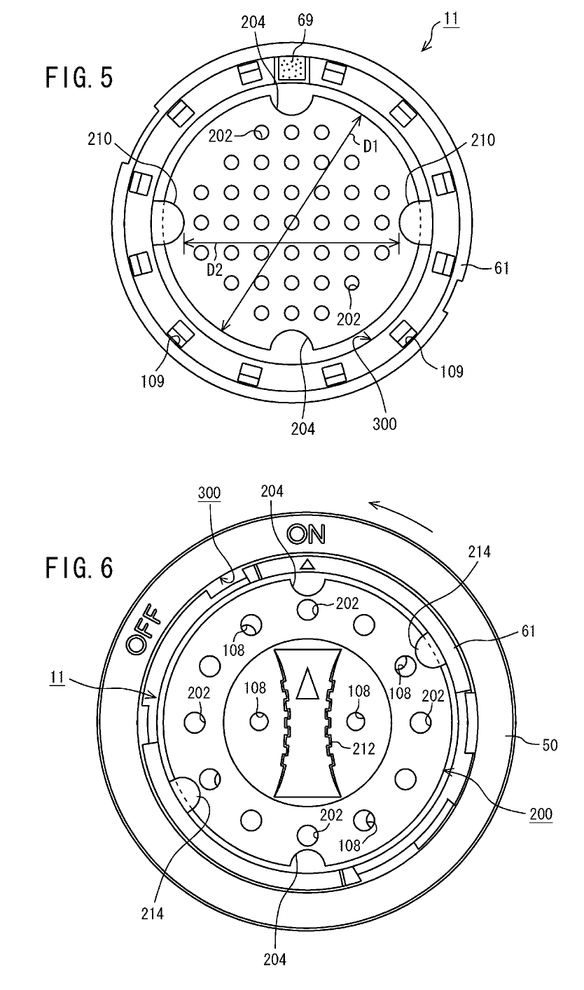

The example of FIG. 2 illustrates an example in which the washing-agent-reception portion 300 is provided on the side of the rear surface of the lid body 11 and on the side of the inner periphery surface of the body portion 67. In this example, a washing agent package 200 that includes the washing agent 206 is received in the washing-agent-reception portion 300. For that reason, as shown in FIG. 2, a pair of holding portions 210, 210 is provided at a lower end of the body portion 67 of the lid body 11 so as to project from the inner periphery surface of the body portion 67 to the inside direction. There is shown a case in which these holding portions 210, 210 are provided at the body portion 67 of the lid body 11 so as to be faced with each other with them being apart from each other approximately by 180° angle distance. The shape of each of the holding portions 210 is a shape corresponding to the shape of a concave portion 204 (see FIG. 5) of the washing agent package 200, which will be mentioned later, and forms into a semicircle shape in this example. It is constituted such that the washing agent package 200 is mounted on the washing-agent-reception portion 300 through these holding portions 210, 210 and can be fixed in the washing-agent-reception portion 300 in that state.

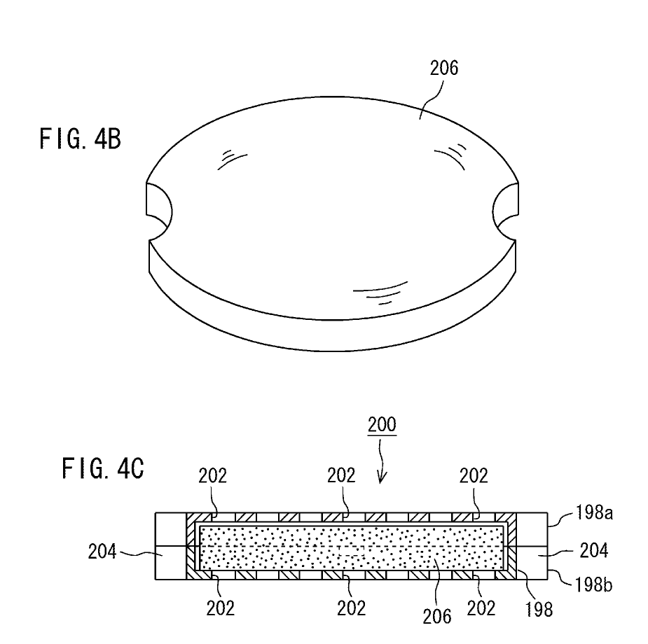

FIG. 4A is a perspective view of the washing agent package 200 for showing a configuration thereof, FIG. 4B is a perspective view of the washing agent 206 for showing a configuration thereof and FIG. 4C is a cross-sectional view of the washing agent package 200 taken along a line of A-A in FIG. 4A.

The washing agent package 200 is, as shown in FIG. 4A to FIG. 4C, constituted by a pair of upper and lower circular flat containers 198 (198a, 198b) which are held and attached with the washing agent 206 being received therein. A pair of concave portions 204, 204 is provided at two places on the periphery of the circular containers 198a, 198b. These concave portions 204, 204 are semicircle shaped concave portions which are selected so as to be somewhat larger than the outward appearances of the holding portions 210 of the lid body 11 and are provided with them being apart from each other approximately by 180° distance so as to have correspondence with the pair of holding portions 210, 210. In order to insert and mount the washing agent package 200 in and on the inner circumferential side of the body portion 67 of the lid body 11, the diameter of each of the circular containers 198a, 198b is selected so as to become somewhat smaller than the diameter of the inner circumference of the body portion 67 of the lid body 11. This is because the holding portions 210, 210 of the lid body 11 can hold the portion of the circular containers 198a, 198b excluding the concave portions 204, 204. A plurality of openings 202 are perforated on the upper surface of the circular container 198a and the lower surface of the circular container 198b, respectively, as shown in FIG. 4A and FIG. 4C. Thus, the water flown from the through-holes 108 for water injection of the lid body 11 is guided into the washing agent package 200. By adjusting the diameter of each of the openings 202, it is possible to adjust an amount of the washing agent 206 which is dissolved from (flown out of) the washing agent package 200.

As the washing agent 206 which is received in the inside of the circular containers 198a, 198b, for example, a general neutral detergent, an enzyme decomposing the oil content, one removing the slime, or one having a function of sterilization, disinfection, aroma, mold prevention, repression of microbe generation or the like, which is dissolved moderately with respect to the water and forms a solid state shape (powder is included) to have approximately a disk shape as shown in FIG. 4B, is suitably used in the present embodiment. This washing agent 206 may be used as a gel-state or liquid-state washing agent 206, but in this case, the diameters of the openings 202 provided on the circular containers 198a, 198b are made small in order to prevent the washing agent 206 from being dissolved at one time out of the circular containers 198a, 198b. By setting the diameter size of each of the openings 202 appropriately, it is possible to adjust the amount of the washing agent 206 which is dissolved from the washing agent package 200. The washing agent 206 is preferably used as an agent that is in conformity with a shape or a size of the circular containers 198a, 198b, but it may have a size which can be received in the circular containers 198a, 198b. For example, it is also allowed to fill up a plurality and a lot of washing agent grains which are formed into predetermined particle diameters.

In this manner, by receiving the washing agent 206 in the circular containers 198a, 198b, even if the washing agent 206 is dissolved by the water-supply and becomes smaller gradually, the sizes of the circular containers 198a, 198b remain unchanged, so that it is possible to prevent the washing agent 206 from dropping from the side of the rear surface of the lid body 11 to the inside of the hopper 3. This enables the washing agent 206 to be used until the end thereof, thereby allowing reduction in cost therefor to be attempted.

It should be noted that the washing agent 206 is not limited to the washing agent package 200 in which the washing agent 206 is received in the circular containers 198a, 198b. For example, it is also possible to use one in which the washing agent surface is covered by a transparent film or the like. In this case, it is enough if there are provided a plurality of openings for passing the water to be supplied through the film and the washing agent package. Also, it is also allowed to employ a constitution in which protrusions are provided on the inner periphery surface of the bottom portion of the circular container 198b such that a space which becomes a flow path of the water can be formed between the washing agent 206 received in the circular containers 198a, 198b and the circular container 198b.

FIG. 5 is a cross-sectional view showing a state in which the washing agent package 200 is mounted on a side of the rear surface of the lid body 11. In order to mount the above-mentioned washing agent package 200 on the washing-agent-reception portion 300 provided on the rear surface of the lid body 11, first, the washing agent package 200 is fitted-in while the pair of holding portions 210, 210 of the side of the rear surface of the lid body 11 and the concave portions 204, 204 of the washing agent package 200 are faced mutually and next, the washing agent package 200 is rotated in a predetermined direction. Thus, since the diameter D1 of the washing agent package 200 excluding the concave portions 204, 204 is larger than the facing distance D2 between the holding portions 210, 210 of the lid body 11, the holding portions 210, 210 can hold the portion of the washing agent package 200 excluding the concave portions 204, 204, which enables the washing agent package 200 to be received and fixed in the washing-agent-reception portion 300.

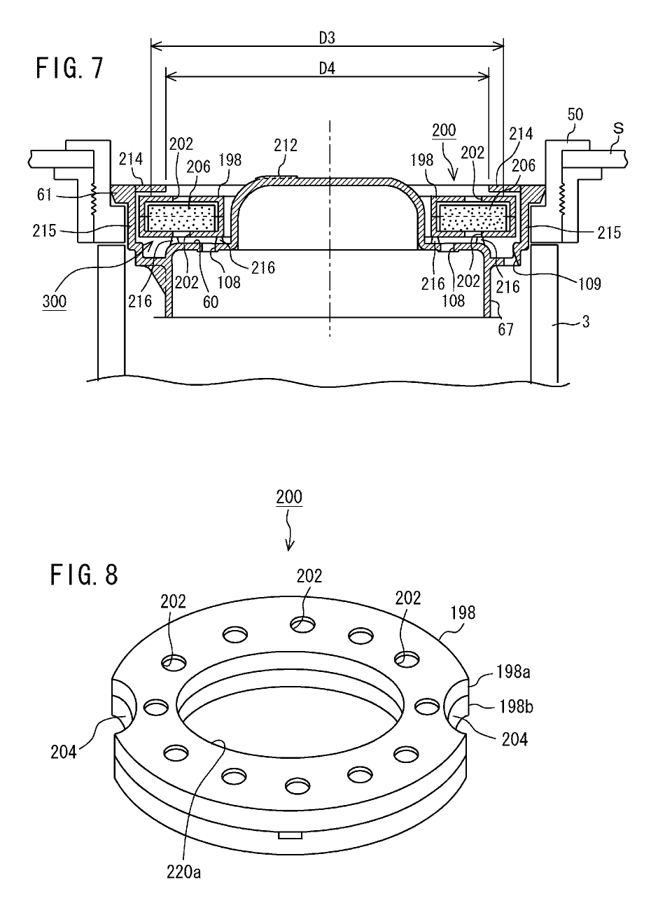

The following will describe a modified example of the washing-agent-reception portion 300. FIG. 6 is an example in which the washing-agent-reception portion 300 is provided on a side of the upper surface of the lid body 11. In this example, as shown in FIG. 7, a top surface side body portion 215 is used and a space which is formed by this body portion 215 is used as the washing-agent-reception portion 300. FIG. 8 is a perspective view of the washing agent package 200 for showing a configuration thereof.

As shown in FIG. 6 and FIG. 7, a pair of position fixing portions 214, 214, which project in the inward direction from the inner periphery surface of the engagement flange 61, for fixing the washing agent package 200 at a predetermined position is provided at an upper end of the engagement flange 61. The pair of position fixing portions 214, 214 is provided on the top surface side body portion 215 of the lid body 11 so as to be faced with each other with them being apart from each other approximately by 180° angle distance. The shape of each of the position fixing portions 214, 214 is formed corresponding to the shape of the concave portion 204 (see FIG. 8) of the washing agent package 200. Each of the concave portions 204, 204 forms into approximately a semicircular shape seen from a plane.

In an area of the top surface plate 60 of the lid body 11 excluding the through-hole area for water injection, there are formed, as shown in FIG. 7, a plurality of protrusion shaped support members 216. These support members 216 are members which space the washing agent package 200 from the top surface plate 60 of the lid body 11 slightly. This causes the space surrounded by the washing agent package 200 and the support members 216 to constitute a pathway of the water, along which the washing liquid passed through the inside of the washing agent package 200 flows smoothly and flows-in into the hopper 3 by way of the through-holes 108 for water injection of the top surface plate 60. It should be noted that a diameter of each of the support members 216 is set so as to be smaller than a diameter of each of the through-holes 108 for water injection, in order to avoid disturbing the water flow.

As shown in FIG. 7 and FIG. 8, the circular containers 198a, 198b of the washing agent package 200 include the upper and the lower circular containers 198a, 198b, a basic configuration of which is same as that of FIG. 4A. In order to avoid overlapping with the handle portion 212 when the washing agent package 200 is mounted on the upper surface of the lid body 11, the washing agent package 200 is constituted as a ring-shaped body having an opening portion 220a which forms approximately a circular shape in the center portion thereof. A diameter of the opening portion 220a becomes an inner diameter which is somewhat larger than a longitudinal length of the handle portion 212. A plurality of openings 202 are perforated respectively on the upper surface of the upper circular container 198a and on the lower surface of the lower circular container 198b along the circumference direction of each of the circular containers 198a, 198b.

It is needless to say that the washing agent 206 received in the inside of the circular containers 198a, 198b has a ring-shaped body corresponding to the shapes of the circular containers 198a, 198b.

In order to receive and fix such a washing agent package 200 in the washing-agent-reception portion 300, similarly as the above-mentioned example, first, the pair of position fixing portions 214, 214 on the side of the upper surface of the lid body 11 and the concave portions 204, 204 of the washing agent package 200 are fitted-in (pushed down) with them being faced mutually. Thereafter, the washing agent package 200 is rotated in a predetermined direction (an arrow direction in FIG. 6). As shown in FIG. 7, a diameter D3 of the washing agent package 200 excluding the concave portions 204 is larger than a facing distance D4 between the position fixing portions 214, 214 of the lid body 11, so that the washing agent package 200 can be received and fixed in the washing-agent-reception portion 300.

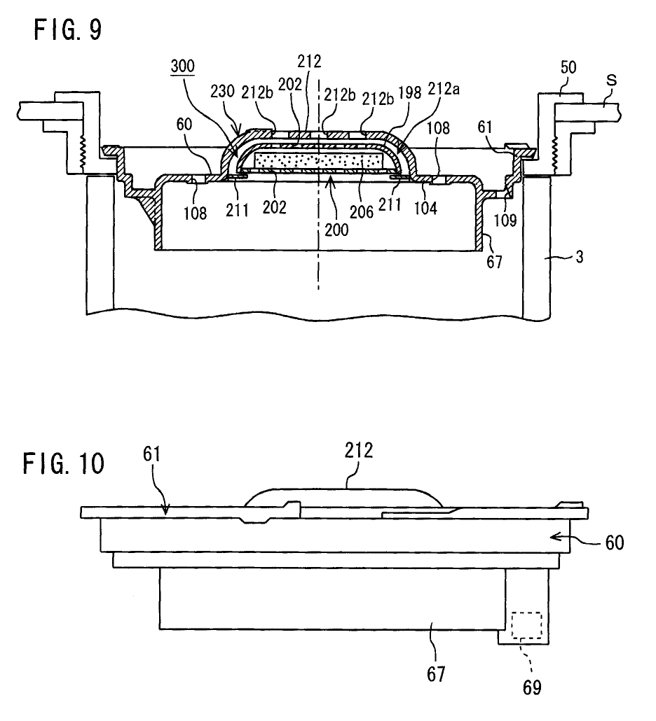

FIG. 9 shows a second modified example of the washing-agent-reception portion 300. The washing-agent-reception portion 300 shown in FIG. 9 is a portion which utilizes the hollow portion 212a on a side of the rear surface of the handle portion 212 as the washing-agent-reception portion 300, and is provided with a plurality of guide orifices 212b through which the water to be supplied passes into the inside of lid body 11 at the periphery surface of the handle portion 212. A pair of holding portions 211, 211, each of which forms approximately a semicircular shape like those mentioned above, is provided at lower ends on a side of the rear surface of the handle portion 212. On the other hand, the washing agent package 200 corresponds to a shape of the hollow portion 212a and there is used a package in which the pair of semicircle shaped concave portions 204, 204 (see FIG. 4A) is formed. By fitting the washing agent package 200 into the hollow portion 212a of the side of the rear surface of the handle portion 212 via the holding portions 211, 211, it is possible to receive and fix the washing agent package 200 in the washing-agent-reception portion 300.

Meanwhile, as shown in FIG. 10, the magnet 69 is mounted and fixed at a predetermined position of the lid body 11. On the other hand, a proximity sensor 232 is provided at a position of the mounting means 2, which corresponds to the magnet 69 of the lid body 11, as shown in FIG. 1. Then, it is constituted such that the magnet 69 corresponding to a crushing mode and the proximity sensor 232 come close to each other by rotating the lid body 11 to a predetermined position and a driving mode of the disposer apparatus 1 is changed over to the crushing mode. As position detection means of the lid body 11, it can be constituted by using the plural magnets 69 and the plural magnetic sensors 232.

The following will describe a configuration of the crushing unit 4 which is applicable to the disposer apparatus 1 using the above-mentioned lid body 11.

The crushing unit 4 is a unit of a grinder system, is constituted by a plurality of crushing blades and is constituted by stacking five crushing blades in this example. In other words, as shown in FIG. 1, the first rotary crushing blade 12, the first fixed crushing blade 13, the second rotary crushing blade 14, the second fixed crushing blade 15 and the third rotary crushing blade 16 are stacked in their orders so that the crushing unit 4 is constituted. A crushing room is constituted by holding the crushing unit 4 on the inner surface of the hopper 3.

The first rotary crushing blade 12, the first fixed crushing blade 13, the second rotary crushing blade 14, the second fixed crushing blade 15 and the third rotary crushing blade 16 are set in size so as to overlap in a state in which there is little upper or lower space and when the crushed raw garbage is entered into upper and lower gaps between the crushing blades, it does not remain in the crushing unit 4.

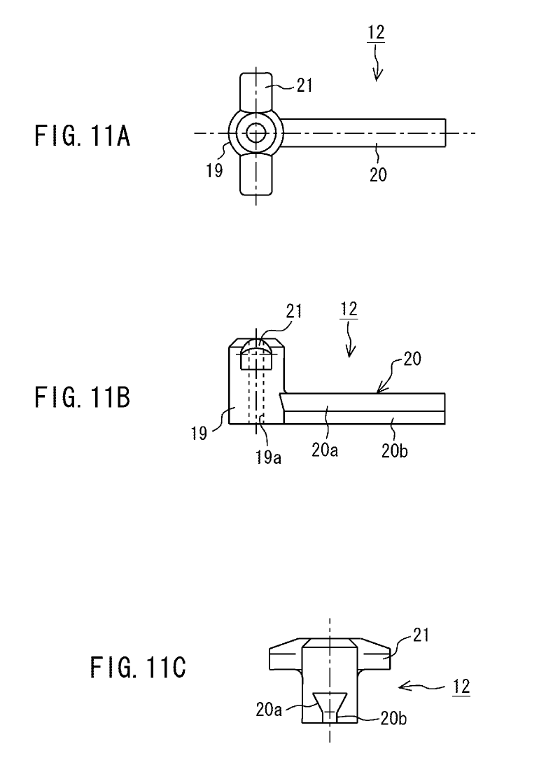

FIG. 11A to FIG. 11C show the first rotary crushing blade 12 which is arranged at the highest stage of the crushing unit 4, in which FIG. 11A is a plan view thereof, FIG. 11B is a front elevational view thereof and FIG. 11C is a right side elevational view of FIG. 11B. The first rotary crushing blade 12 includes one piece of stirring arm 20 extending horizontally from a side portion of a bearing unit 19. The first rotary crushing blade 12 is formed so that pushing surfaces 20a are formed on both of the front and back surfaces in the rotation direction of the stirring arm 20.

The pushing surfaces 20a are inclined surfaces (tapered surfaces) which are inclined in a direction in which an upper end is projected with respect to a lower end on both of the side surfaces of the stirring arm 20. By forming the pushing surfaces 20a on both of the side surfaces of the stirring arm 20, the first rotary crushing blade 12 can add a pressing force downward with respect to the raw garbage which is contacted with the pushing surfaces 20a by the rotating operations in both directions of the forward rotation direction and the reverse rotation direction. Thus, the first rotary crushing blade 12 takes in the raw garbage by the rotating operations thereof and presses it down to the crushing blades of the lower stages.

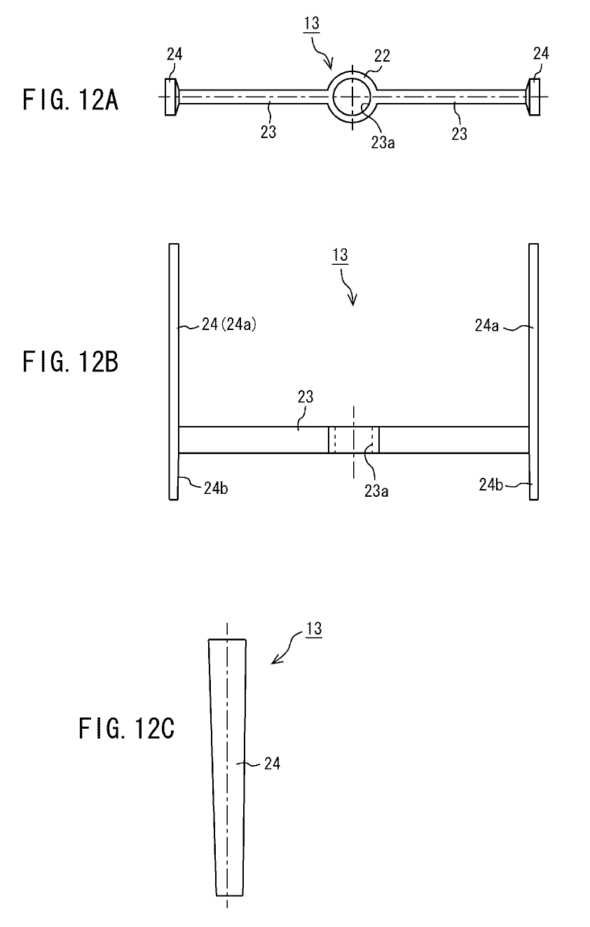

The first rotary crushing blade 12 is formed so that edges 20b are formed on sides of the lower ends of both of the side surfaces of the pushing surface 20a, and functions as a crushing blade for crushing the raw garbage roughly in cooperation with the first fixed crushing blade 13 shown in FIG. 12A to FIG. 12C.

In the first rotary crushing blade 12, a handle 21 is formed on the upper surface of the stirring arm 20. The handle 21 is provided at a position apart by 90° from the stirring arm 20 so as to extend only by the same lengths for the left and right sides from the bearing unit 19. The handle 21 functions as a grasp unit (handle) when pulling up the crushing unit 4.

In order to use the grasp unit, the handle 21 is selected so as to have a length of such a degree that a finger can be placed. On the bearing unit 19, a through-hole 19a is perforated through which a shaft head portion (fastening portion) of a rotation driving shaft 36 (see FIG. 1) provided at the third rotary crushing blade 16, which will be mentioned later, can be passed. The through-hole 19a has approximately a D-type shape as seen from the above and consequently, the corresponding portion within the rotation driving shaft 36 has also approximately a D-type shape as seen from the above, so that both are integrated rotationally.

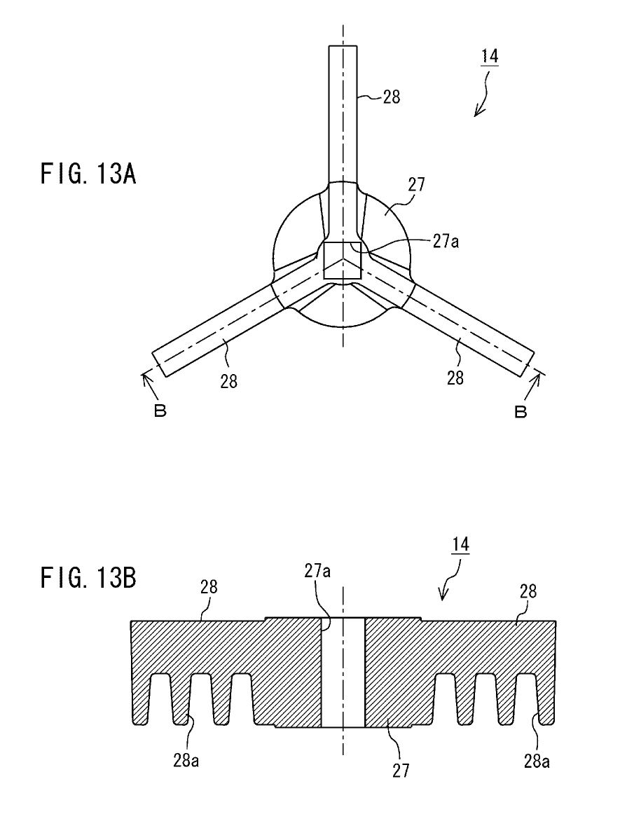

FIG. 12A to FIG. 12C show the first fixed crushing blade 13 arranged at the lower stage of the first rotary crushing blade 12, in which FIG. 12A is a plan view, FIG. 12B is a front elevational view and FIG. 12C is a right side elevational view thereof. The first fixed crushing blade 13 includes two pieces of arms 23 extending horizontally from a hub 22 and apart from each other with interval of 180°. Each arm 23 has a flat plate shape and edges are formed on the upper and lower ends on both of the side surfaces and it functions as the crushing blade in cooperation with the above-mentioned first rotary crushing blade 12 and the second rotary crushing blade 14 shown in FIG. 13A and FIG. 13B.

A tab 24 which functions as rotation blocking means is provided at each tip of each arm 23. The tab 24 is an arm which extends in upward and downward directions so as to extend in the longitudinal direction of the hopper 3 and restricts the rotation of the first fixed crushing blade 13 by fitting this tab 24 in the fitting groove 3a (see FIG. 1) of the hopper 3. In this example, a long tab whose whole length is selected is used taking into consideration an attachment position (depth) of the first rotary crushing blade 12 with respect to the hopper 3.

The reason why the long tab 24 is employed is, first, that the rotation restriction with respect to the first fixed crushing blade 13 is reliably executed. Second, the fitting groove 3a is filled by the tab 24 so that the vacant spot of the fitting groove 3a is reduced as much as possible. For that reason, a tab 24a provided by being extended upward is selected so as to become longer as much as several times than a tab 24b provided downward with respect to the arm 23, which causes a fitting length with respect to the fitting groove 3a to be lengthened.

Also, by forming the upper side tab 24a to be long in this manner, the vacant spot from a side of the throw-in opening portion 7 to the tip of the upper side tab 24a is reduced when the hopper 3 is mounted with the crushing unit 4 as shown in FIG. 1, which prevents the crushed raw garbage from being stuck in the fitting grooves 3a.

As shown in FIG. 12C, the tab 24 is selected so that the width of the upper end side thereof becomes approximately the same as the width of the fitting groove 3a, and it becomes narrower slightly while going to the lower end. This is because a backlash decreases after attaching the tab 24 with respect to the fitting groove 3a and the engagement of the tab 24 with respect to the fitting groove 3a is more smoothly executed.

The lower side tab 24b is provided so that a gap of a predetermined height is formed when the second rotary crushing blade 14 intervenes between the first fixed crushing blade 13 and the second fixed crushing blade 15. For that reason, in this example, the length of the lower side tab 24b is selected to be approximately a half of the length of the second rotary crushing blade 14 until a blade tip thereof.

A diameter of an inner opening 23a of the hub 22 is larger than a diameter of the shaft portion of the second rotary crushing blade 14 shown in FIG. 13A and FIG. 13B or a diameter of the rotation driving shaft 36, and is selected to be a size which does not interfere with the shaft portion of the second rotary crushing blade 14 and the rotation driving shaft 36 respectively.

FIG. 13A and FIG. 13B show the second rotary crushing blade 14. The second rotary crushing blade 14 is arranged at the lower stage of the first fixed crushing blade 13. FIG. 13A is a plan view thereof and FIG. 13B is a cross-sectional view taken along B-B lines thereof.

The second rotary crushing blade 14 is provided with three pieces of arms 28 extending radially from a hub 27 with an interval by 120°. Each arm 28 is constituted to have a slightly shorter radius than the inner diameter of the hopper 3 so as not to contact with the inner wall of the hopper 3. For each arm 28, a comb-like portion 28a having a predetermined pitch is formed on the bottom surface thereof.

An engagement opening 27a is perforated at a center portion of the hub 27 of the second rotary crushing blade 14 and is fitted with the rotation driving shaft 36 (see FIG. 1), which causes a rotating force to be applied to the second rotary crushing blade 14. For that reason, similarly as the second rotary crushing blade 14, the engagement opening 27a which contacts the second rotary crushing blade 14 is formed as a non-circle shape (for example, square opening) so as to be rotationally integrated with the rotation driving shaft 36. Similarly as those mentioned above, it is also allowed to employ approximately a D-typed shape as seen from the above.

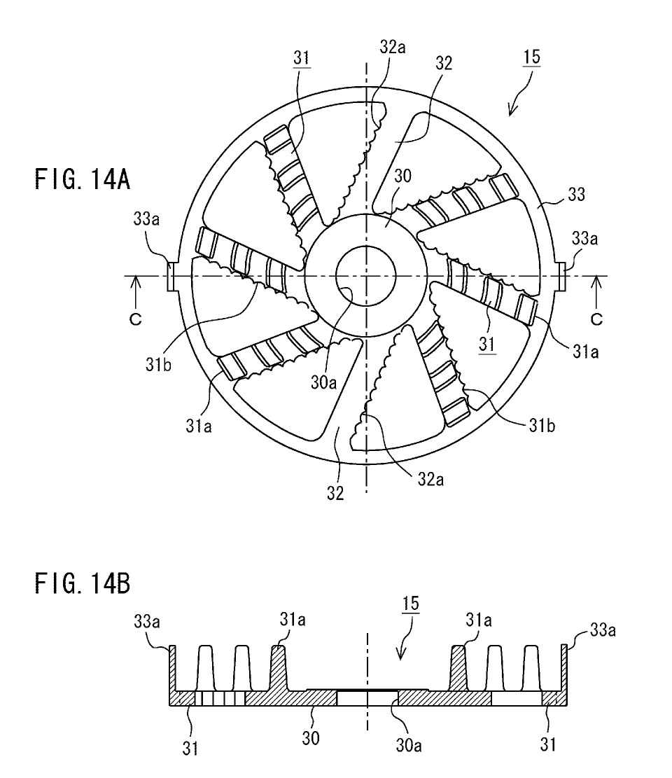

FIG. 14A and FIG. 14B respectively show one example of the second fixed crushing blade 15. The second fixed crushing blade 15 is arranged at the lower stage of the second rotary crushing blade 14 so as to engage with the second rotary crushing blade 14. FIG. 14A is a plan view and FIG. 14B is a cross-sectional view taken along a C-C line thereof.

The second fixed crushing blade 15 has a shape in which eight pieces of arms 31 extending radially from a hub 30 in the tangent line direction with equal distances are surrounded by a ring 33. A pair of tabs 33a is formed in the outer circumference of the ring 33 with an interval by 180°. The pair of tabs 33a functions as rotation blocking means for fixing the second fixed crushing blade 15 on the hopper 3. For that reason, the pair of tabs 33a is formed as plate bodies each having a slightly narrower width than the width of each of the fitting grooves 3a formed on the inner wall of the hopper 3 so as to be able to be fitted thereinto. This width is approximately the same as the width of the tab 24b of the first fixed crushing blade 13. The rotation of the second fixed crushing blade 15 is restricted by attaching and fitting the tabs 33a in the fitting grooves 3a.

Each of these tabs 33a has a predetermined height and is selected to have a size so that when the lower side tabs 24b of the first fixed crushing blade 13 contacts the upper surfaces of the tabs 33a, a gap of a predetermined height is formed between the first fixed crushing blade 13 and the second fixed crushing blade 15 and the second rotary crushing blade 14 is precisely engaged. A center opening 30a of the hub 30 is constituted so as to have a size which does not interfere in the rotation driving shaft 36.

In the second fixed crushing blade 15, the six pieces of arms 31 among the eight pieces of arms 31 are formed with their upper surfaces being comb-like portions 31a. Each of the comb-like portions 31a of the second fixed crushing blade 15 has such a pitch that the comb-like portion 28a of the second rotary crushing blade 14 shown in FIG. 13A and FIG. 13B can pass through a space between the teeth thereof and, as shown in FIG. 1, by overlapping the second rotary crushing blade 14 and the second fixed crushing blade 15, a slight gap is formed between the comb-like portions 28a, 31a of both the sides.

Thus, the comb-like portions 31a of the second fixed crushing blade 15 crush the raw garbage fed-in from the crushing blades of the upper stages in cooperation with the comb-like portions 28a of the second rotary crushing blade 14.

As mentioned above, since the arms 28 of the second rotary crushing blade 14 are three pieces and the arms 31 of second fixed crushing blade 15 are eight pieces, the space between the arms 31 are narrow with respect to the space between the arms 28.

Consequently, when all of the eight pieces of the arms 31 are provided with the comb-like portions 31a, it becomes a state in which the comb-like portions 31a of the second fixed crushing blade 15 exist among the arms 28 of the second rotary crushing blade 14 for every case and when a block shaped garbage with a certain size is thrown-in, a situation is assumed in which the raw garbage does not enter the space between the arms 28 of the second rotary crushing blade 14, which is difficult to crush it.

Consequently, by providing no comb-like portion 31a for, for example, two pieces of arms 32 among the eight pieces of arms 31 in the second fixed crushing blade 15, it is configured that a wide space is formed in the circumferential direction if the arm 31 without being provided with the comb-like portion 31a of the second fixed crushing blade 15 is positioned between the arms 28 of the second rotary crushing blade 14 during the rotating operation of the second rotary crushing blade 14.

Thus, even if the block shaped raw garbage having a certain extent of size is thrown-in, the raw garbage enters into the space between the arms 28 of the second rotary crushing blade 14 so that the raw garbage is crushed by the rotating operation of the second rotary crushing blade 14 in cooperation with the comb-like portion 28a and the comb-like portion 31a of another arm 31 of the second fixed crushing blade 15.

It should be noted that since the crushing ability is lowered when the number of the arms 31 without being provided with the comb-like portion 31a are large in the second fixed crushing blade 15, it is preferable that, as shown in the drawing, around two pieces of arms 32 without being provided with the comb-like portion 31a are employed when, for example, eight pieces of arms 31 are provided.

Based on a fact that each arm 32 is extended radially along the tangent line direction of the hub 30, when the second rotary crushing blade 14 rotates, peak repression of the crushing load and planarization of the load are attempted by deviating crushing points with respect to the second fixed crushing blade 15 toward the circumferential direction thereof.

The second fixed crushing blade 15 is formed, as shown in FIG. 14A, with pressing surfaces 31b, 32a on a side surface positioned on the rotation direction side within the side surfaces of the respective arms 31, 32. Each of the pressing surfaces 31b, 32a is a wave surface which is formed as a wave shape having a taper in which the lower end thereof is made shorter than the upper end thereof. It is constituted such that forming the pressing surfaces 31b, 32a as the wave surfaces allows the raw garbage to be caught by the concave portion having the taper thereof, which restrains the raw garbage from moving in the radial direction thereof to crush the raw garbage reliably.

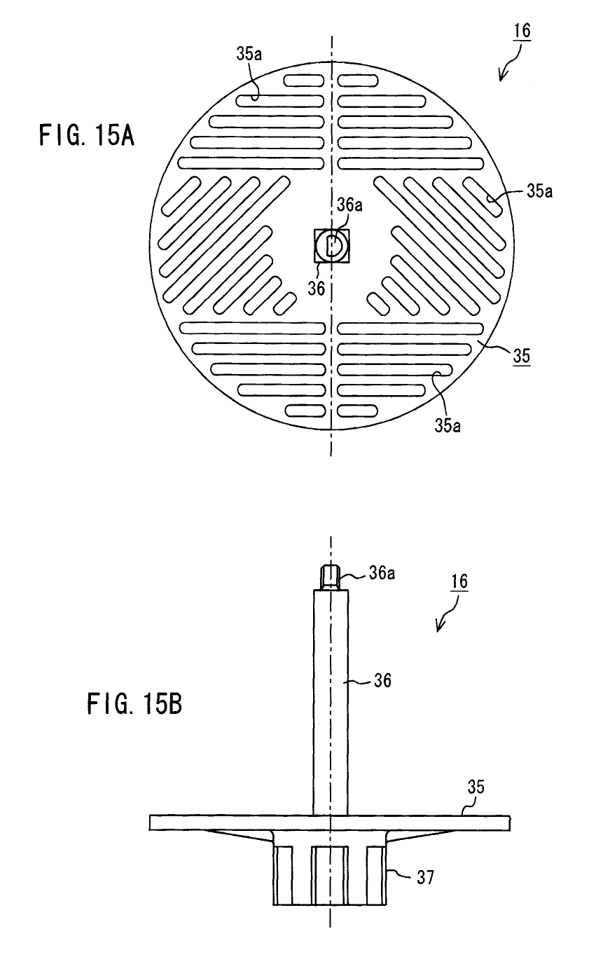

FIG. 15A and FIG. 15B show one example of the third rotary crushing blade 16, in which FIG. 15A is a plan view thereof and FIG. 15B is a side view thereof.

The third rotary crushing blade 16 is configured as a disk 35 and arranges a plurality of slits 35a on the whole surface of the disk 35 excluding a hub 36 at the center thereof. In the third rotary crushing blade 16 of the present example, plural groups of slits are formed and the neighboring slits 35a are arranged, in each slit group, so as to be approximately in parallel to each other.

An upper surface of the third rotary crushing blade 16 is a plane and rotates while contacting with a bottom surface of each of the arms 31 of the second fixed crushing blade 15 shown in FIG. 14A and FIG. 14B. Also, the slits 35a shown in FIG. 15A and FIG. 15B pass through the third rotary crushing blade 16 from a front thereof to a back thereof, and a sharp edge is formed at the opening edge portion on a side of the upper surface of each of the slits 35a.

The upper surface of the third rotary crushing blade 16 executes a rotating operation while frictionally engaging with the bottom surfaces of the arms 31 of the second fixed crushing blade 15 and since the wave surfaces 31b, 32a inclined toward the bottom surface side are formed on the one surface of each of the arms 31 and 32 of the second fixed crushing blade 15, it is possible to add a force pressed to this third rotary crushing blade 16 with respect to the raw garbage (crushed until a size to a certain degree) contacting with the wave surface 31b, 32a by a rotating operation of the third rotary crushing blade 16.

The raw garbage, which is crushed by means of the comb-like portions 28a of the second rotary crushing blade 14 (FIG. 13A and FIG. 13B) and the comb-like portions 31a of the second fixed crushing blade 15 (FIG. 14A and FIG. 14B) and is dropped onto the upper surface of the third rotary crushing blade 16, is caught by the slits 35a, and the raw garbage is pressed into the slits 35a by the wave surfaces 31b, 32a depending on the rotation of the third rotary crushing blade 16. Owing to this rotating operation, the raw garbage is crushed by the edge portion of each of the slits 35a. Then, the raw garbage crushed finely passes through the slits 35a, drops downward, passes through the bottom plate 9 of the hopper 3 shown in FIG. 1, and is discharged from the drainage pipe connection port 8 to the outside.

It should be noted with since each of the slits 35a is formed so that an opening portion (or opening step portion) thereof become wider toward a side of the bottom surface thereof, the raw garbage pressed down into each of the slits 35a is easy to drop.

At the center portion of the third rotary crushing blade 16, the rotation driving shaft 36 is molded integrally with the disk 35. The rotation driving shaft 36 is formed to have a shape such that it can be rotationally integral with the first and second rotary crushing blades 12 and 14 and can be rotationally free with respect to the first and second fixed crushing blades 13 and 15. For that reason, the rotation driving shaft 36 corresponding to the first and second rotary crushing blades 12 and 14 is formed as a square shaft portion (fitting shaft portion) and the portion excluding that is formed as a round shaft. Then, a screw portion is formed at a shaft head portion thereof and is constituted so as to function as a fastening portion 36a.

A fitting portion 37 which functions as a portion of the rotation driving shaft 36 is provided on the lower surface of the disk 35 and is constituted so as to be engaged with the driving shaft 10 of the above-mentioned deceleration unit and to be driven and rotated. The fitting portion 37 is made so that inner hole 37a (see FIG. 1) thereof is made to be a square hole, in order to make the fitting state with the driving shaft 10 in good condition. It is also allowed to employ a hexagonal hole. Also, it is assumed that the fitting length of the fitting portion 37 is selected such that the fitting portion 37 can have a sufficient fitting state with respect to the driving shaft 10 of the deceleration unit as much as possible.

The first rotary crushing blade 12, the first fixed crushing blade 13, the second rotary crushing blade 14, the second fixed crushing blade 15 and the third rotary crushing blade 16 which are constituted in this manner are aligned in this order and are stacked one another by passing therethrough the rotation driving shaft 36 provided at the third rotary crushing blade 16. Then, as shown in FIG. 1, the crushing unit 4 in which a plurality of crushing blades 12 to 16 are integrated is obtained by screwing a screw 29a from an upper end of the fastening portion 36a, which is the shaft head portion of the rotation driving shaft 36, and fastening it. At that time, the integration is achieved in a state in which the position relations of the tabs 24 of the first fixed crushing blade 13 and the tabs 33a of the second fixed crushing blade 15 are adjusted so that they are continuous (aligned in a straight line).

Then, the crushing unit 4 is moved downward in the hopper 3 along the fitting grooves 3a while fitting the tabs 24 and 33a along the fitting grooves 3a. At that time, the crushing unit 4 is moved downward by utilizing the grasp unit 21. When the crushing unit 4 is moved downward until the bottom surface portion of the hopper 3, the fitting portion 37 provided at the third rotary crushing blade 16 is fitted with the driving shaft 10 of the deceleration unit shown in FIG. 1.

Here, both the tabs 24, 33a of the crushing unit 4 are simply mounted in the fitting grooves 3a and it is not necessary to fix the tabs 24 and 33a at the hopper 3 by screws or the like. This is because the crushing unit 4 can be held on the hopper 3 stably by using the long tabs 24 and the relatively short tabs 33a. Extending the tab 24 comparatively long in this manner allows the fixation of the crushing unit 4 in the hopper 3 to be realized reliably in a state in which the rotation thereof is blocked. The crushing unit 4 is only simply fitted with the hopper 3, so that it is possible to pull up the crushing unit 4 easily. For that reason, it is possible to execute the cleaning of the hopper 3, the crushing unit 4 and the like readily.

The crushing unit 4 has such a structure that it is fixed directly on the hopper 3, but it may have such a structure that housing is prepared and the crushing unit is fixed in this housing.

Since the crushing unit 4 is fitted with the driving shaft 10 depending on the self weight thereof, it never happens that the rotation driving shaft 36 is dropped-off from this driving shaft 10 during an operation of the apparatus.

The crushing treatment using the above-mentioned crushing unit 4 is as follows:

Raw garbage is thrown-in from the throw-in opening portion 7 and when the throw-in opening portion 7 is closed by the lid body 11, the control means detects that the lid body 11 has been closed and allows the drive motor to rotate. Specifically, there is executed a rotating operation in which operations of the forward rotation and the reverse rotation are repeated for every few seconds, for example, for every five seconds. For the motor rotation speed, it is set to be around 100 rpm, which restrains noises or vibrations from being generated.

A plurality of through-holes for water injection (which will be mentioned later) is formed at the lid body 11 and it is constituted such that water supply into the hopper 3 is available even if the throw-in opening portion 7 is closed by the lid body 11. During the crushing treatment of the raw garbage, water supply into the inside of the hopper 3 is executed by flowing water into the kitchen sink S or the like.

When the drive motor rotates, the crushing unit 4 rotates with the first rotary crushing blade 12, the second rotary crushing blade 14 and the third rotary crushing blade 16 rotating together. On the other hand, owing to the actions of the tabs 24, 33a, any one of the first fixed crushing blade 13 and the second fixed crushing blade 15 does not rotate.

The raw garbage thrown-in into the hopper 3 from the throw-in opening portion 7 is stirred by the stirring arm 20 of the first rotary crushing blade 12 and is crushed roughly in cooperation with the arms 23 of the first fixed crushing blade 13 of the lower stage and at the same time, the crushed raw garbage is fed into the space between the arms 28 of the second rotary crushing blade 14.

The crushed raw garbage which has been fed into the space between the arms 28 of the second rotary crushing blade 14 is finely crushed by the engagement of the comb-like portion 28a of each of the arms 28 and the comb-like portion 31a of each of the arms 31 of the second fixed crushing blade 15 of the lower stage owing to the rotation of the second rotary crushing blade 14.

The second fixed crushing blade 15 is provided with the arms 32 having no comb-like portion 31a among the plurality of arms 31, so that when each of the arms 32 having no comb-like portion 31a is positioned between the arms 28 of the second rotary crushing blade 14 on the rotation of the second rotary crushing blade 14, a large space can be formed in the circumferential direction. Thus, even large raw garbage of a block shape or the like enters into the space between the arms 28 of the second rotary crushing blade 14 and is finely crushed by the engagement of the comb-like portion 28a thereof and the comb-like portion 31a of another arm 31 of the second fixed crushing blade 15 owing to the rotation of the second rotary crushing blade 14. Thus, it is possible to crush raw garbage in which various sized ones are mixed depending on a combination of a small number of fixed crushing blades and rotary crushing blades.

The raw garbage crushed in cooperation with the second rotary crushing blade 14 and the second fixed crushing blade 15 is discharged from the slits 35a by a cooperation of each arm 31 of the second fixed crushing blade 15 and the third rotary crushing blade 16.

When the raw garbage contacts the wave surfaces 31b, 32a of the arms 31 and 32 of the upper stage side by the rotation of the third rotary crushing blade 16, the raw garbage receives a force for pressing it downward, which is the direction of the third rotary crushing blade 16, depending on an inclination angle of each of the wave surfaces 31b, 32a.

Thus, the raw garbage is pressed into the slits 35a by the wave surfaces 31b, 32a depending on the rotation of the third rotary crushing blade 16, further pushed down by the wave surfaces 31b, 32a while being crushed by the edges of the opening edge portions of the slits 35a at the upper surface side thereof, and drops downward by passing through the slits 35a.

As mentioned above, each of the slits 35a has a step in which the opening of a side of the bottom surface thereof becomes large, so that the raw garbage pushed down into the slits 35a drops downward without being clogged in the slits 35a. It should be noted that the crushing unit 4 crushes the raw garbage while repeating the forward rotation and the reverse rotation.

As explained above, in the present embodiment, when the disposer apparatus 1 is changed over to the crushing mode, the water supply to the inside of the disposer apparatus 1 is started together with the crush of the garbage by the crushing unit 4. This water to be supplied is supplied to the inside of the disposer apparatus 1 by making the lid body 11 as the pathway. Here, as mentioned above, the lid body 11 is provided with the washing-agent-reception portion 300 on the pathway of the water to be supplied in the lid body 11 at the regions such as the rear surface side thereof, the front surface side thereof and the rear side of the handle portion 212. For that reason, the water to be supplied is supplied to the inside of the hopper 3 while dissolving the washing agent 206 when passing through the lid body 11. Namely, the washing liquid in which the washing agent 206 is dissolved in the water is supplied to the inside of the hopper 3. Thus, concurrently with the crushing treatment of the garbage, the washing in the inside of the hopper 3 is executed. Consequently, it is possible to keep the inside of the hopper 3 clean in a state in which the crushing unit 4 is mounted on the hopper 3 without being detached therefrom.

It should be noted that although the example has been explained in the above-mentioned explanation in which the separate region such as the rear surface side of the lid body 11, the front surface side thereof or the rear surface side of the handle portion 212 is made as the washing-agent-reception portions 300 and the washing agent 206 is provided therein, it is allowed to combine them and provide the washing agents 206, for example, in two places of washing-agent-reception portions 300 of the rear surface side and the front surface side of the lid body 11 respectively or it is also allowed to provide the washing agents 206 in all three places. Also, the present invention is also applicable to a disposer apparatus of an automatic water supply type by which water is supplied from an electric faucet. In brief, it can be applied widely to the disposer apparatus 1 of the system which executes water-supply in the inside of the hopper 3 by way of the lid body 11 from the upper surface side of the lid body 11.

### Second Embodiment

Although the disposer apparatus 1 of a manual water supply type or of a type which executes water-supply from the electric faucet has been described in the first embodiment, a disposer apparatus 1 of an automatic water supply type will be described in the present embodiment. It should be noted that other configuration of the disposer apparatus 1 is similar as that of the first embodiment, so that the same reference numerals are put on the common components and the detail explanation thereof will be omitted.

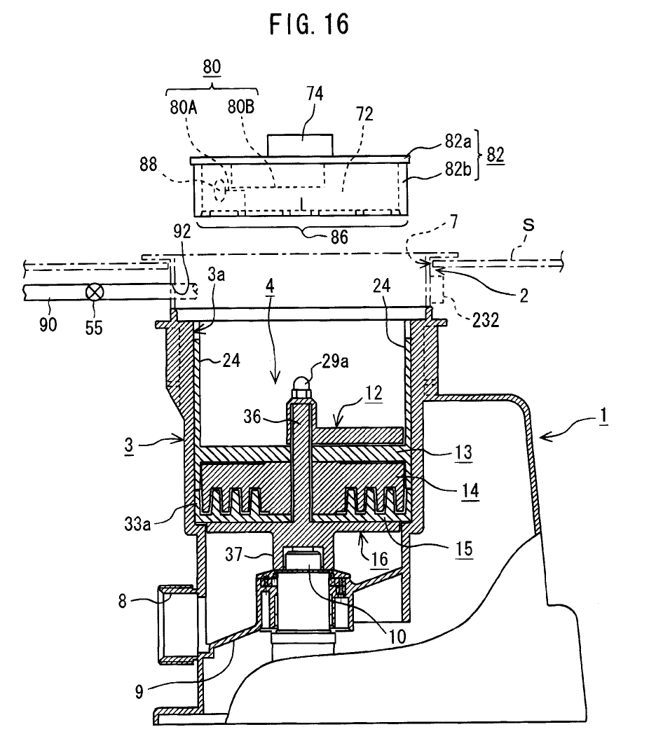

FIG. 16 is a cross-sectional view of the disposer apparatus 1 of the automatic water supply type for showing a configuration thereof.

A supply port 92 of the tap water is provided at the upper periphery surface of the hopper 3 and this supply port 92 is coupled to a connection pipe (hose) 90 through an opening and closing valve (for example, solenoid valve) 55.

A lid body 82 includes an upper lid 82a and a middle lid 82b, which are used by being integrated by means of screws (not shown) or the like. An inner space which is formed by the upper lid 82a and the middle lid 82b functions as a storage portion 72 of the water, and a water supply port 88 for supplying the tap water, as shown in the drawing, is provided at a predetermined position of an outer wall of the middle lid 82b. The supply port 92 is positioned at a position facing the water supply port 88.

FIG. 17 shows a configuration of a side of the rear surface 73b of the upper lid 82a. A side of the rear surface 73b thereof is made to be a concave portion 76 having the same depth as height of a grasp unit 74 corresponding to the grasp unit 74 provided on a side of the upper surface 73a. Also, a guiding partition portion 80B constituting a portion of a guiding water dispersion unit 80 is provided so as to be communicated with this concave portion 76.

The guiding water dispersion unit 80 is provided in order to disperse the water into the middle lid 82b after collecting it in the center portion of the lid body 82. Consequently, the guiding partition portion 80B functions as a member which is used for dispersing the water to the middle lid 82b side by collecting it in the center portion of the lid body 82.

For that reason, this guiding partition portion 80B is constituted by a water-guiding path 81a whose one end side is opened and a convergent path 81b which is communicated with this water-guiding path 81a. As shown in FIG. 17, when the convergent path 81b is arranged approximately in parallel with a horizontal axis O1, an opening portion of the water-guiding path 81a is provided such that it is directed to the lower side, becomes approximately in parallel with respect to a vertical axis O2 and moreover becomes in a way of widening a little bit toward the end. These water-guiding path 81a and convergent path 81b are provided in a hanging manner on a side of the rear surface 73b of the upper lid 82a as partitions in which both thereof are made to have the same height.

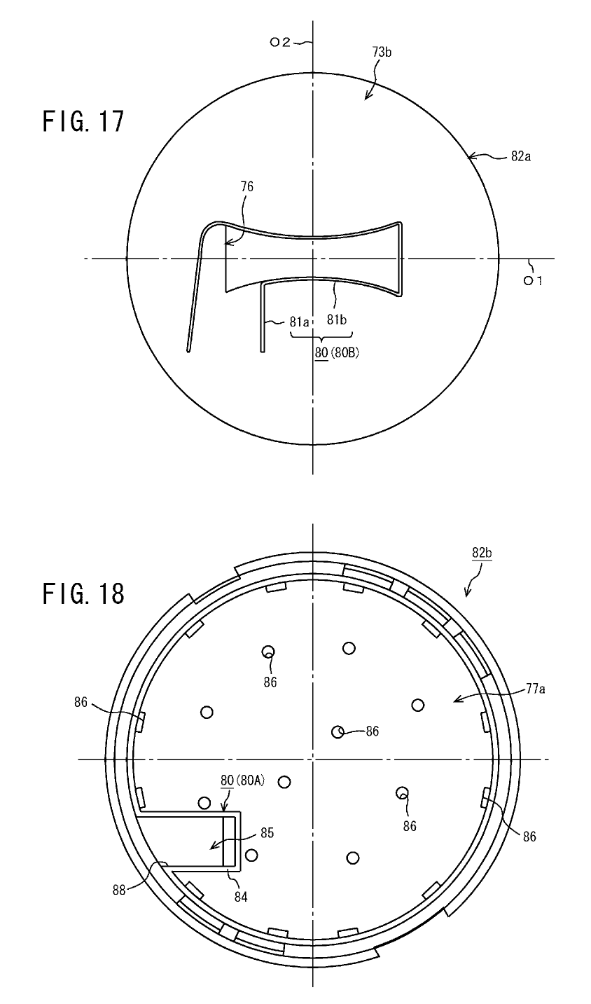

FIG. 18 shows a configuration of the middle lid 82b. A plurality of circular shaped sprinkler ports 86 is perforated radially at a bottom portion 77a of the middle lid 82b in this example. At positions of the bottom portion 77a, which are contacted with the outer wall surface thereof, there are perforated sprinkler ports 86 which form rectangular shapes over the plural places thereof.

Also, as shown in FIG. 18, one water injection partition portion 80A constituting the guiding water dispersion unit 80 with it being in communication with the water supply port 88 is provided at the bottom portion 77a of the middle lid 82b. The water injection partition portion 80A is a portion standing from the bottom portion 77a as a partition 84 which forms approximately a U-shape, and the width thereof is slightly narrowed as compared with that of the water-guiding path 81a (see FIG. 17) of the guiding partition portion 80B. This is because the water poured into the water injection partition portion 80A is delivered to a side of the water-guiding path 81a without waste as much as possible. For that reason, there is further formed a slope portion 85 (see FIG. 20 mentioned later) whose bottom portion is protuberant at the water injection partition portion 80A.

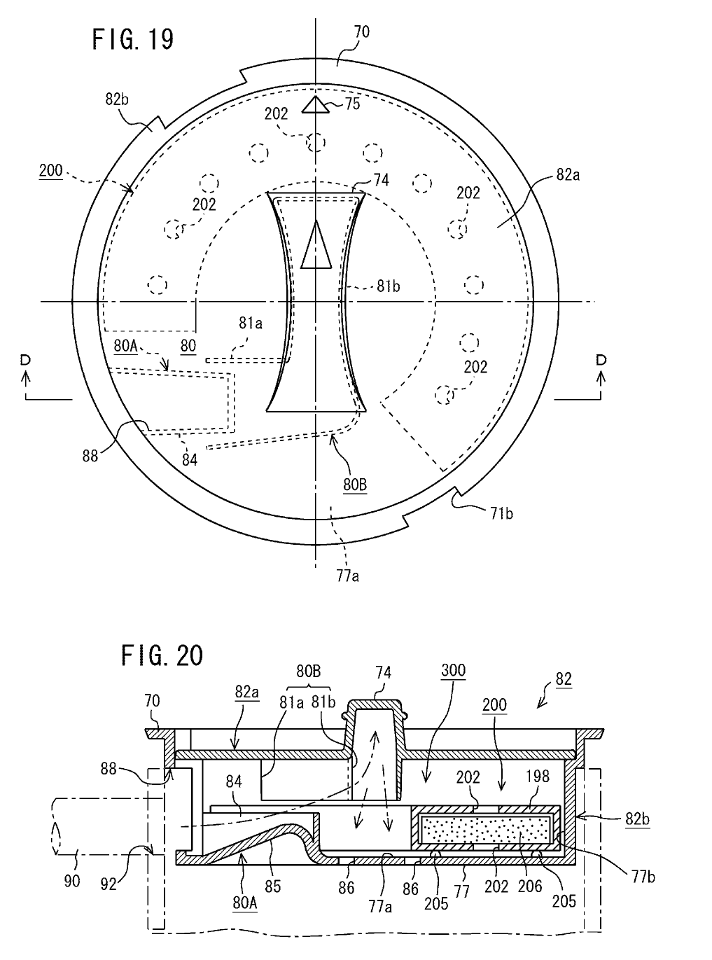

The following will describe a pathway of the water to be supplied in the lid body 82 with reference to FIG. 19 and FIG. 20. Here, FIG. 19 shows a configuration of a plane of the lid body 82 in a state of being mounted with the upper lid 82a and FIG. 20 shows a cross-sectional view taken along a D-D line in FIG. 19.

As shown in FIG. 20 by chain line arrows, the water supplied from the water supply port 88 receives any restriction in a water-flowing direction so as to be directed to the upper lid 82a along the slope portion 85, that is, a side of the convergent portion 81b through the water-guiding path 81a. As a result thereof, the water concentrates on the side of the convergent portion 81b. The water converged on a side of the convergent portion 81b, in this time, falls toward the middle lid 82b. The convergent portion 81b is provided approximately at a center portion of the upper lid 82a, so that the water dropping occurs approximately to all directions and the water is spread over the whole bottom surface of the middle lid 82b. As a result thereof, the plurality of sprinkler ports 86 are formed at the bottom portion 77 of the middle lid 82b, so that the water is supplied into the hopper 3 from the side of these sprinkler ports 86 approximately thoroughly and uniformly.

Now, in the present embodiment, the washing-agent-reception portion 300 is provided in the lid body 82 which executes the automatic supply. Specifically, the space in the middle lid 82b is used as the washing-agent-reception portion 300. Namely, the washing agent package 200 as shown in FIG. 19 and FIG. 20 is received on the sprinkle pathway of the water to be supplied, which is the bottom portion 77a of the middle lid 82b. A container 198 of this washing agent package 200 is approximately a ring-shaped body which forms approximately a C-shape so as to be matched with the bottom portion space. An inner circumference diameter of the washing agent package 200 is selected to be approximately the same length as the length in the longitudinal direction of the convergent portion 81b of the upper lid 82a. Both the opened tip portions of the C-shape for the washing agent package 200 are provided with a little bit spaces in order not to contact with the water-guiding path 81a of the upper lid 82a and the water injection partition portion 80A of the middle lid 82b. In this manner, the washing agent package 200 is arranged at a position at which it does not overlap with the guiding water dispersion unit 80 provided at the upper lid 82a and the middle lid 82b, respectively, seen by a plane view. This is because the function of the guiding water dispersion unit 80 is not disturbed. Also, thickness of the washing agent package 200 is selected to be thinner than that of the side wall lower end of this convergent portion 81b, because the water falls uniformly from the side wall lower end of the convergent portion 81b to the whole bottom surface of the middle lid 82b. Thus, it becomes easy for the water dropping from the convergent portion 81b to flow into the inside of washing agent package 200 from the water feed openings 202 provided on the inner circumference side surface and on the upper surface of the washing agent package 200.

A plurality of protrusion shaped support members 205 is formed in a non-sprinkler port area of the bottom portion 77a of the middle lid 82b. These support members 205 are ones allowing for arranging the washing agent package 200 apart from the bottom portion 77a of the middle lid 82b. Thus, the space surrounded by the washing agent package 200 and the support members 205 becomes the pathway of the water, it becomes easy to flow the washing liquid passing through the inside of washing agent package 200 and the supplied water smoothly and to flow them into the sprinkler ports 86 on a side of the bottom portion 77a of the middle lid 82b.

It should be noted that although a case in which the washing agent package 200 containing the washing agent 206 in the container 198 thereof is received in the washing-agent-reception portion 300 in the middle lid 82b has been explained in the present embodiment, the washing agent 206 may be received in the washing-agent-reception portion 300 in the middle lid 82b as it is without using the container 198. This is because the middle lid 82b constituting the lid body 82 includes the bottom portion 77a and includes a tube shaped side wall 77b which is standingly provided upward from the periphery of this bottom portion 77a, so that even if the washing agent 206 is dissolved by the supplied water, it is held by the bottom portion 77a and the side wall 77b of the middle lid 82b and does not drop.

Also, although the C-shaped package has been used for the washing agent package 200 and has been arranged at the periphery of the center portion of the inside of the middle lid 82b in the present embodiment, it is not limited to this. For example, by using a place just beneath the convergent portion 81b of the middle lid 82b as the washing-agent-reception portion 300, the washing agent 206 may be received therein, and by using the concave portion 76 of the rear surface side of the grasp unit 74 of the upper lid 82a as the washing-agent-reception portion 300, the washing agent 206 may be received therein. In this case, it is preferable for the thickness of the washing agent package 200 to be selected so as to be spaced by a constant distance with respect to the side wall lower end of the convergent portion 81b in order not to disturb the function of the guiding water dispersion unit 80.

Also in a case of the disposer apparatus 1 of the automatic water supply type in the present embodiment, similarly as the above-mentioned first embodiment, the washing agent 206 is provided in the inside of the lid body 82, so that the washing liquid is supplied to the hopper 3 by the water supply during the crushing treatment. Thus, the washing operation of the inside of the disposer apparatus 1 is executed concurrently with the crushing treatment of the garbage. Consequently, it is possible to keep the inside of the hopper 3 clean in a state in which the crushing unit 4 is mounted without being detached from the hopper 3.

### Third Embodiment

In the first embodiment, even if the driving mode of the disposer apparatus 1 is other mode than the crushing mode, the washing agent 206 is exposed to the water and is dissolved when the water from the faucet is used in a state in which the lid body 11 is mounted on the disposer apparatus 1. On the other hand, the present embodiment is different from the first embodiment in a configuration such that the washing agent 206 is exposed to the water only when the driving mode of the disposer apparatus 1 remains in a period of crushing mode time. It should be noted that other configurations of the disposer apparatus 1 are similar to those of the first embodiment, so that the same reference numerals are put on the common components and the detail explanation thereof will be omitted.

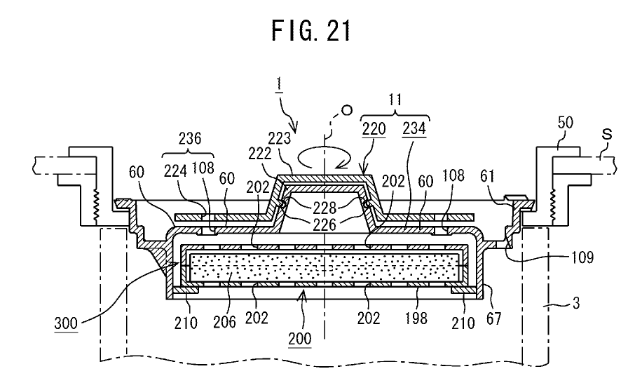

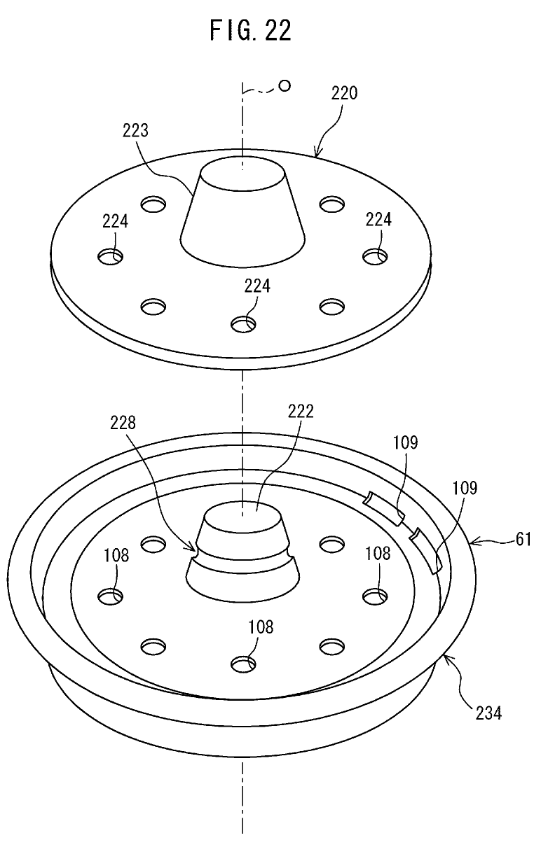

FIG. 21 is a cross-sectional view of the lid body 11 for showing a configuration thereof and FIG. 22 is an exploded perspective view of the lid body 11 for showing a configuration thereof.

As shown in FIG. 21, the lid body 11 has a lid main body 234 and an operation lid 220 for controlling the supply of the washing agent 206 to the hopper 3.

At approximately a center portion of the upper surface of the lid main body 234, a handle portion 222 having a conical trapezoid shape which is projected from this upper surface is provided. On the side surface of the handle portion 222, a groove portion 228 is provided along a circumferential direction of this side surface (see FIG. 22). This groove portion 228 is a portion to which a protrusion portion 226 provided at the operation lid 220, which will be mentioned later, is fitted. Also, the through-holes 108 (first holes) for water injection are perforated at the lid main body 234 to guide the supplied water into the inside of the hopper 3, and the through-holes 109 for water injection each forming a rectangular shape are perforated in a vicinity of the coupling circumference portion with respect to the engagement flange 61.

The operation lid 220 is formed as a shape covering approximately a whole surface of the top surface plate 60 of the lid main body 234 and the handle portion 222, and includes a handle portion 223 with a conical trapezoid shape which is provided at a center portion of the top surface plate 60. On an inner periphery surface of the handle portion 223 of the operation lid 220, as shown in FIG. 21, the protrusion portion 226 corresponding to a shape of the above-mentioned groove portion 228 of the lid main body 234 is formed along the circumferential direction thereof. Thus, the protrusion portion 226 of the operation lid 220 and the groove portion 228 of the lid main body 234 are fitted, so that the operation lid 220 is rotatably mounted on the lid main body 234 around a rotation axis O thereof.

Also, guide holes 224 (second holes) for guiding the water to be supplied to the inside of the lid main body 234 are formed at positions of the operation lid 220 facing the through-holes 108 for water injection which are formed on the lid main body 234.

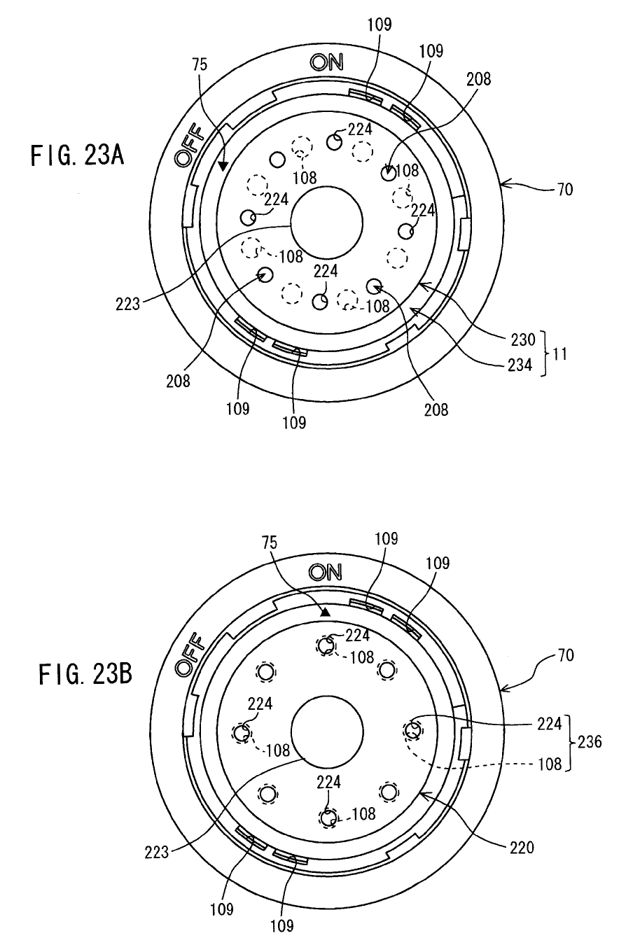

The following will describe an operation of the lid body 11 during the crushing mode and an operation of the lid body 11 during other mode than the crushing mode. FIG. 23A is a diagram explaining the operation of the lid body 11 during other mode than the crushing mode, and FIG. 23B is a diagram explaining the operation of the lid body 11 during the crushing mode. Here, also in a moment of other mode than the crushing mode, it is assumed that the tap water is used as the washing water of the dish washing or the like in a state in which the lid body 11 is mounted on the hopper 3.

As shown in FIG. 23A, in a moment of other mode than the crushing mode, when, for example, washing of the dishes or the like is executed, a mark 75 of the lid main body 234 is matched with an “OFF” position. At that time, the operation lid 220 is rotated until a position at which the guide holes 224 of the operation lid 220 and the through-holes 108 for water injection of the lid main body 234 do not overlap (are deviated) when seen by a plane view. Here, it is assumed that, for example, a stopper is provided at the groove portion 228 of the lid main body 234, the rotation of the operation lid 220 stops at the above-mentioned position and the operation lid 220 is locked. Thus, the guide holes 224 of the operation lid 220 are shielded by the top surface portion 60 (shielding portion 208) of the lid main body 234, and the water supplied from the upper side of the lid body 11 cannot pass through the guide holes 224 of the operation lid 220 and the through-holes 108 for water injection of the lid main body 234. The water supplied to the upper surface of the operation lid 220 flows to a side of the engagement flange 61 and is supplied to a side of the hopper 3 through the through-holes 109 for water injection in the vicinity of the coupling circumference portion with respect to the engagement flange 61. Since the through-holes 109 for water injection in the vicinity of the coupling circumference portion are perforated on the outside of the cylindrical body portion 67, the washing agent package 200 received in the inside of the body portion 67 is not exposed to the water dropped from the through-holes 109 for water injection.

The following will describe a moment of the crushing mode.

First, from the state shown in FIG. 23A, the lid main body 234 is rotated clockwise as shown in the drawing and the mark 75 of the lid main body 234 is matched with an “ON” position. From the state thereof, the operation lid 220 is further rotated clockwise until a position at which the guide holes 224 of the operation lid 220 and the through-holes 108 for water injection of the lid main body 234 overlap when seen by a plane view, and a state shown in FIG. 23B is obtained. At that time, it is assumed that the rotation of the operation lid 220 stops at the above-mentioned position by the above-mentioned stopper and the operation lid 220 is locked. Thus, guide holes 236 (third holes) are constituted by superposing the guide holes 224 of the operation lid 220 and the through-holes 108 for water injection of the lid main body 234, to guide the supplied water to the inside of the lid body 11. The mark 75 of the lid main body 234 has been already matched with the “ON” position, so that the driving of the disposer apparatus 1 has been changed over to the crushing mode and the water supply from the upper portion of the lid body 11 to the inside of the hopper starts. The water supplied to the upper surface of the operation lid 220 passes through the guide holes 224 of the operation lid 220 and the through-holes 108 for water injection of the lid main body 234, and is supplied to the washing agent package 200 received in the rear surface side of the lid main body 234. The supplied water is supplied to the inside of hopper as a washing liquid including the washing agent 206 with dissolving the washing agent 206 in the washing agent package 200. When ending the driving operation in the crushing mode of the disposer apparatus 1, it is enough if the reverse operations of the above-mentioned procedures are executed, that is, the guide holes 236 (third holes) are sealed by rotating the operation lid 220 counterclockwise and thereafter, the mark 75 is matched with the “OFF” position by rotating the lid main body 234 counterclockwise.

According to the present embodiment, the washing agent 206 is contacted with the water through the guide holes 236 only during the crushing mode, so that the washing agent 206 is blocked from being used during a moment of other mode than the crushing mode, which enables the waste of the washing agent 206 to be eliminated.

Also, according to the present embodiment, the rotation direction of the operation lid 220 when constituting the guide holes 236 and the rotation direction of the lid main body 234 when changing over the driving of the disposer apparatus to the crushing mode become the same direction. Consequently, it is possible to execute the changeover to the crushing mode and supply changeover of the washing agent 206 by a minimum operation. Also, if the operation of the operation lid 220 is not executed after the position of the mark 75 is matched with the “ON” position from the “OFF” position by rotating only the lid main body 234 clockwise, the water cannot be supplied to the washing agent 206, so that the supply of the washing liquid to the inside of the hopper 3 is not executed. On the other hand, the water supply from the through-holes 109 for injection to the inside of the hopper 3 is executed, so that it is possible to use the disposer apparatus 1 similarly as a conventional disposer apparatus 1, which enables the consumption of the washing agent 206, which is undesired by a user, to be repressed. In addition, when executing the washing of dishes and the like while executing water feed from the faucet of the kitchen sink S, by getting a state in which the guide holes 236 (third holes) are constituted by rotating the operation lid 220 clockwise under a state in which the mark 75 of the lid main body 234 is matched with the “OFF” position beforehand, it is possible to execute the washing of the inside of the disposer apparatus 1 by using the drainage when washing dishes or the like even if the disposer apparatus 1 is not used.

It should be noted that the technical scope of the present invention is not limited to the above-mentioned embodiments and includes scopes in which various modifications are added to the above-mentioned embodiments without departing from the gist of the present invention.

For example, although this invention has been applied to the disposer apparatus of the grinder type and with a detachable system in the above-mentioned embodiments, it can be easily understood that this invention can be applied to a disposer apparatus of the hammermill type or a chain-mill type starting with a disposer apparatus with non-detachable system and also can be applied to the lid bodies which are used for these disposer apparatuses.

### INDUSTRIAL APPLICABILITY

This invention can be used for a kitchen of general households such as an apartment house and a one-unit house, or that of a restaurant and the like.

1. A lid body characterized in that a lid main body which is constituted so as to be removably from a throw-in port of a disposer apparatus main body for throwing-in garbage and changes over the disposer apparatus main body to an operation thereof for crushing the thrown-in garbage together with water to be supplied,
wherein the water to be supplied is supplied to the disposer apparatus main body through the lid main body as a pathway, and
wherein a washing-agent-reception portion is provided at a portion of the pathway of the lid main body at least.

2. The lid body according to claim 1, characterized in that a handle portion is provided on an upper surface of the lid main body with it projecting from the upper surface, and
the washing-agent-reception portion is provided at a periphery portion of the handle portion of the lid main body.

3. The lid body according to claim 1, characterized in that the washing-agent-reception portion is provided on a rear surface side of the lid main body through a holding member, and
an opening for guiding the supplied water to a side of a rear surface of the lid main body is perforated in the lid main body.

4. The lid body according to claim 1, characterized in that a handle portion is provided on an upper surface of the lid main body with it projecting from the upper surface thereof and at the same time, a hollow portion on a side of a rear surface of the handle portion of the lid main body is made to be the washing-agent-reception portion;
a holding member is provided at the hollow portion on the side of the rear surface of the handle portion; and
an opening for guiding the supplied water to the hollow portion on the side of the rear surface of the handle portion is perforated at the handle portion.

5. The lid body according to claim 1, characterized in that the lid main body includes an upper lid and a middle lid,
the washing-agent-reception portion is provided in the inside of the lid main body, and
an opening for guiding the supplied water to the inside of the lid main body is perforated at a periphery surface of the middle lid.

6. The lid body according to claim 1, characterized in that an operation lid which is provided by covering the lid main body and is mounted so as to be able to rotate relatively with respect to the lid main body;
a first opening which becomes a pathway of the water from the lid main body to the disposer apparatus main body is perforated in the lid main body;
a second opening is perforated in the operation lid at a position with it being superposed on the first opening;
when the disposer apparatus main body is in a crushing operation, a third opening which becomes a pathway of the water is constituted owing to superposition of the first opening on the second opening by rotating at least one of the lid main body and the operation lid to a superposed position of the first opening and the second opening and the washing-agent-reception portion is provided at a portion of the pathway of the water; and
when the disposer apparatus main body is not in a crushing operation, a blocking portion for blocking the pathway of the water is constituted by rotating at least one of the lid main body and the operation lid to a position at which the first opening is not superposed on the second opening.

7. The lid body according to claim 6, characterized in that
the changeover to the crushing operation of the disposer apparatus main body is executed by an operation for rotating the lid main body to a predetermined position, and
a rotation direction of the lid main body constituting the third opening and a rotation direction of the lid body changing over the disposer apparatus main body to a crushing operation thereof are the same rotation direction.
